(19) United States
(12) Patent Application Publication
(10) Pub. No.: US 2005/0057680 A1
(43) Pub. Date: Mar. 17, 2005

(54) Method and apparatus for controlling integration time in imagers

(76) Inventor: Martin J. Agan, Pasadena, CA (US)

Correspondence Address: DICKSTEIN SHAPIRO MORIN & OSHINSKY LLP, 2101 L Street, NW, Washington, DC, 20037, US

(21) Appl. No.: 10/662,445

(22) Filed: Sep. 16, 2003

(51) Int. Cl. H04N 5/235; G03B 7/00

(52) U.S. Cl. 348/362

(57) ABSTRACT

A method and apparatus for controlling integration time in an imager. An embodiment provides a CMOS image sensor having a timing control unit which operates a global reset function, a mechanical shutter operation to mechanically end integration time and a rolling readout. The use of a global reset to start an integration period and a mechanical shutter to end an integration period allows the rolling readout to be conducted without blurring.

### FIELD OF THE INVENTION

The present invention relates to the field of imaging devices, and in particular to a shutter and readout technique for controlling image integration time in a CMOS imager.

### BACKGROUND

Typically, a digital imager array includes a focal plane array of pixel cells, each one of the cells including a photoconversion device, e.g. a photodiode gate, photoconductor, or a photodiode. In a CMOS imager a readout circuit is connected to each pixel cell which typically includes a source follower output transistor. The photoconversion device converts photons to electrons which are typically transferred to a floating diffusion region connected to the gate of the source follower output transistor. A charge transfer device (e.g., transistor) can be included for transferring charge from the photoconversion device to the floating diffusion region. In addition, such imager cells typically have a transistor for resetting the floating diffusion region to a predetermined charge level prior to charge transference. The output of the source follower transistor is gated as an output signal by a row select transistor.

Exemplary CMOS imaging circuits, processing steps thereof, and detailed descriptions of the functions of various CMOS elements of an imaging circuit are described, for example, in U.S. Pat. No. 6,140,630 to Rhodes, U.S. Pat. No. 6,376,868 to Rhodes, U.S. Pat. No. 6,310,366 to Rhodes et al., U.S. Pat. No. 6,326,652 to Rhodes, U.S. Pat. No. 6,204,524 to Rhodes, and U.S. Pat. No. 6,333,205 to Rhodes. The disclosures of each of the foregoing are hereby incorporated by reference herein in their entirety.

In a digital CMOS imager, when incident light strikes the surface of a photodiode, electron/hole pairs are generated in the p-n junction of the photodiode. The generated electrons are collected in the n-type region of the photodiode. The photo charge moves from the initial charge accumulation region to a floating diffusion region or it may be transferred to the floating diffusion region via a transfer transistor depending upon the pixel configuration. The charge at the floating diffusion region is typically converted to a pixel output voltage by a source follower transistor.

FIG. 1 shows a typical simplified timing diagram for the signals used to transfer charge out of a pixel cell of a CMOS imager. As illustrated in FIG. 1, the process begins when the row select transistor (RS) is turned on. A reset transistor is then turned on, which allows the floating diffusion region to be reset to a predetermined voltage (Vᵣₛₜ). The voltage Vᵣₛₜ is sampled and captured in sample and hold circuitry (SHR). A transfer gate voltage (TG) is then applied to the gate of a transfer transistor to cause charge accumulated in a photoconversion device, during an integration period, to transfer to the floating diffusion region. The output voltage (V_{sig}) corresponding to the transferred charge is then sampled by associated sample and hold circuitry (SHS).

Integration time is the amount of time that the pixel is receiving light photons, converting the photons to a charge and accumulating the charge, before the charge is stored or readout. Conventional CMOS imagers may utilize an electronic rolling shutter (ERS) readout technique to control integration time. ERS allows integration times to about one row time (e.g., 1/30,000 for 1.3 million sensor at 30 frames per second). Imagers utilizing ERS techniques do not typically utilize a mechanical shutter. A limitation associated with the use of ERS is that images are readout row by row and therefore, fast moving objects may appear blurry due to the offset in integration times from one row to another. In addition, the relatively slow readout of an imager using ERS creates problems if a flash is to be used when capturing the image.

Other techniques for controlling integration time include the use of a mechanical shutter or an electronic global shutter. Each technique, however, has some drawbacks. For example, when using a mechanical shutter, the entire array must be completely reset prior to opening. In addition, the entire array must be readout after closing the shutter. The mechanical shutter must operate such that it can be precisely controlled for short exposure times at the opening and closing operations, which makes this technique more expensive than other techniques. An electronic global shutter can have leakage of ambient light signals into the imager's memory during readout, which is undesirable. Charge coupled device (CCD) imagers may utilize an electrical/mechanical shutter. In this type of imager, an electronic shutter is used to globally reset the array to initiate integration and a mechanical shutter is used to end the integration.

Thus, there is a desire and need for controlling integration time in a CMOS imager that does not suffer from the above drawbacks.

### SUMMARY

The present method provides a method and apparatus for controlling integration time in an imager. An embodiment of the invention provides a CMOS image sensor having a timing control unit that operates a global reset function, a mechanical shutter operation to mechanically end integration time and a rolling readout function. The use of a global reset to start an integration period and a mechanical shutter to end the integration period allows a rolling readout to be conducted without blurring the image.

### BRIEF DESCRIPTION OF THE DRAWINGS

Additional features of the present invention will be apparent from the following detailed description and drawings which illustrate exemplary embodiments of the invention, in which:

FIG. 1 is a timing diagram for a conventional image sensor;

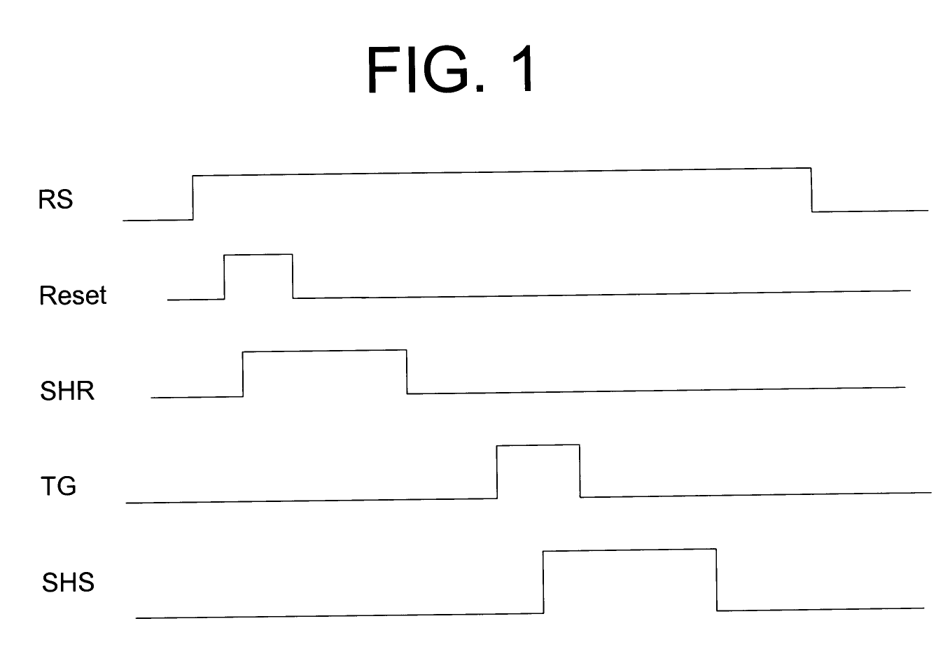

FIG. 2 is a block diagram of an imager device having a pixel array operated in accordance with an embodiment of the invention;

FIG. 3 is a cross-sectional view of a portion of a pixel of an image sensor according to an embodiment of the invention;

FIG. 4 is a timing diagram for an exemplary embodiment of the invention;

FIG. 5 is a cross-sectional view of a portion of a pixel of an image sensor according to an embodiment of the invention;

FIG. 6 is a timing diagram for an exemplary embodiment of the invention; and

FIG. 7 is a schematic diagram of a processing system employing an imager constructed in accordance with any of the various embodiments of the present invention.

### DETAILED DESCRIPTION OF THE INVENTION

In the following detailed description, reference is made to the accompanying drawings, which form a part hereof and show by way of illustration specific embodiments in which the invention may be practiced. These embodiments are described in sufficient detail to enable those skilled in the art to practice the invention, and it is to be understood that other embodiments may be utilized, and that structural, logical, and electrical changes may be made without departing from the spirit and scope of the present invention.

The terms “wafer” and “substrate,” as used herein, are to be understood as including silicon, silicon-on-insulator (SOI) or silicon-on-sapphire (SOS) technology, doped and undoped semiconductors, epitaxial layers of silicon supported by a base semiconductor foundation, and other semiconductor structures. Furthermore, when reference is made to a “wafer” or “substrate” in the following description, previous processing steps may have been utilized to form regions, junctions, or material layers in or over the base semiconductor structure or foundation. In addition, the semiconductor need not be silicon-based, but could be based on silicon-germanium, germanium, gallium arsenide or other semiconductors.

The term “pixel,” as used herein, refers to a photo-element unit cell containing a photoconversion device for converting photons to an electrical signal. For purposes of illustration, a single representative pixel and its manner of formation is illustrated in the figures and description herein; however, typically fabrication of a plurality of like pixels proceeds simultaneously. Accordingly, the following detailed description is not to be taken in a limiting sense, and the scope of the present invention is defined only by the appended claims.

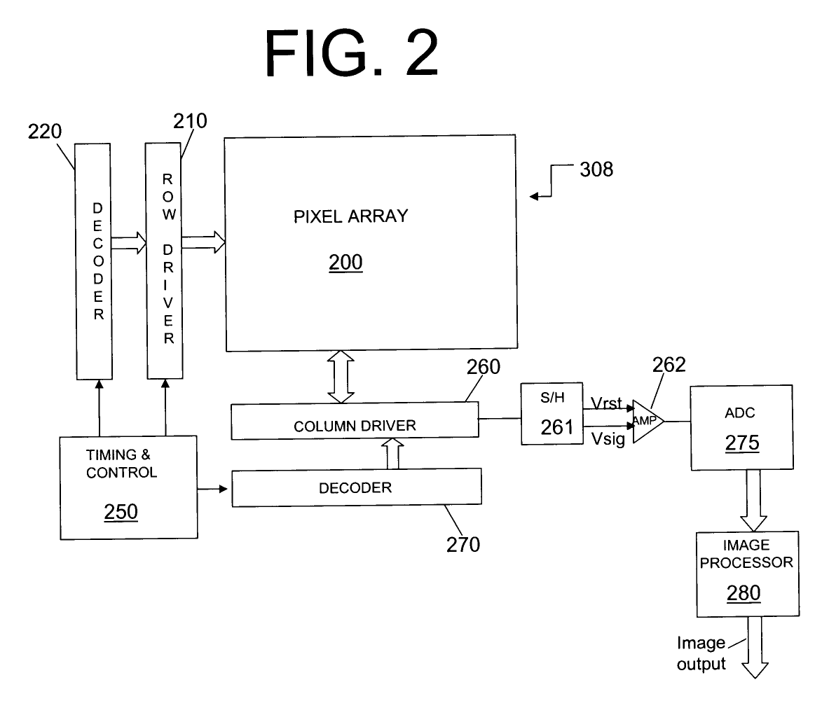

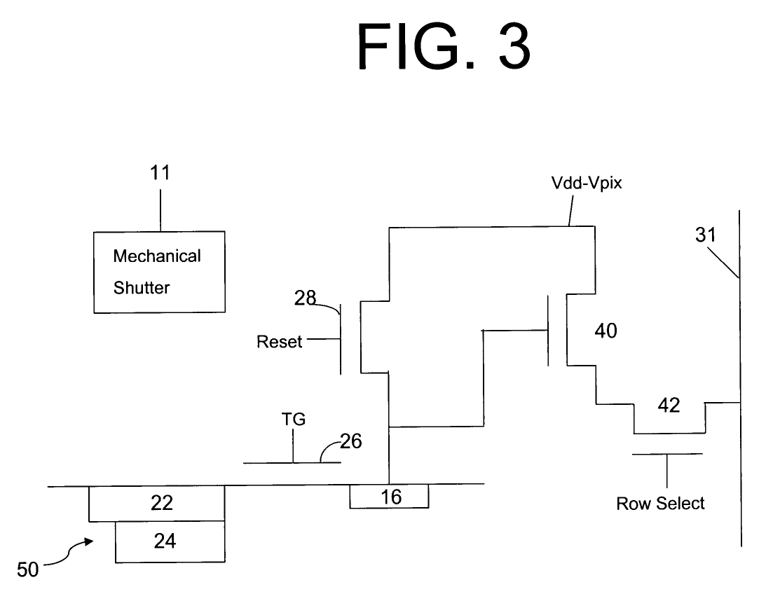

Now referring to the figures, where like reference numbers designate like elements, FIG. 2 illustrates a block diagram of an exemplary imager device 308 that may be used in accordance with an embodiment of the invention. Imager 308 has a pixel array 200 with each pixel cell being constructed as described below with reference to FIG. 3. Row lines are selectively activated by a row driver 210 in response to row address decoder 220. A column driver 260 and column address decoder 270 are also included. The imager is operated by the timing and control circuit 250, which controls address decoders 220, 270. The control circuit 250 also controls the row and column driver circuitry 210, 260. A sample and hold circuit 261 associated with the column driver 260 reads a pixel reset signal (Vᵣₛₜ) and a pixel image signal (V_{sig}) for the selected pixels. A differential signal (Vᵣₛₜ-V_{sig}) is produced by differential amplifier 262 for each pixel. The differential signal is digitized by analog-to-digital converter 275 (ADC). The analog-to-digital converter 275 supplies the digitized pixel signals to an image processor 280 which forms and outputs a digital image.

FIG. 3 illustrates an exemplary four-transistor (4T) pixel sensor cell which is employed in a first embodiment of the invention. The pixel includes a photoconversion device 50 comprising p-type region 22 and n-type region 24 formed in a semiconductor substrate. The photoconversion device 50 is illustratively a photodiode and may be a p-n junction photodiode, a Schottky photodiode, or any other suitable photoconversion device.

A source follower transistor 40 and row select transistor 42 with associated gates are also included in the pixel sensor cell. The output of the row select transistor 42 is connected with a column readout line 31. The remaining structures shown in FIG. 3 include a transfer transistor 26 and a reset transistor 28. An exemplary charge collection region is shown as floating diffusion region 16. A mechanical shutter 11 is also shown for selectively controlling the light impinging on photoconversion device 50.

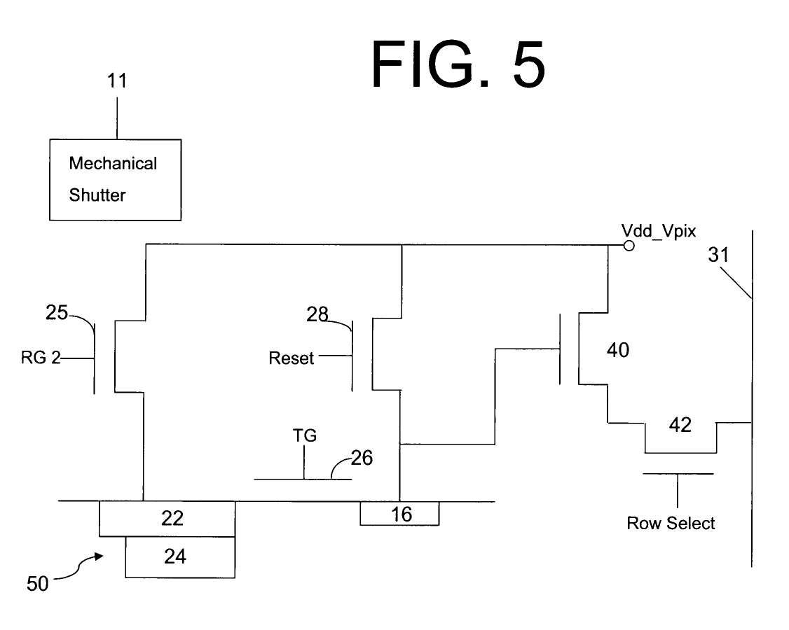

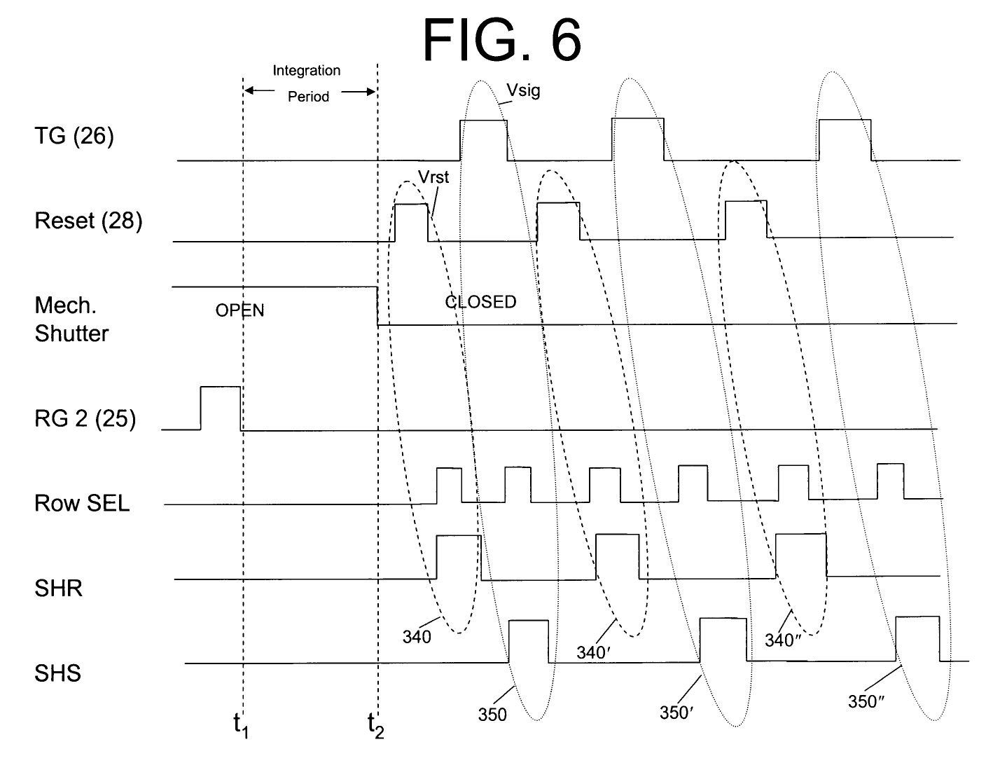

Although shown in FIG. 3 as a four-transistor (4T) configuration including a transfer transistor, the invention can also be utilized in a three-transistor (3T) configuration, without a transfer transistor 26 where the region 24 is directly coupled to floating diffusion region 16. The invention can also be used with pixels having other transistor configurations. An example having a five-transistor (5T) configuration is described below in relation to FIGS. 5 and 6.

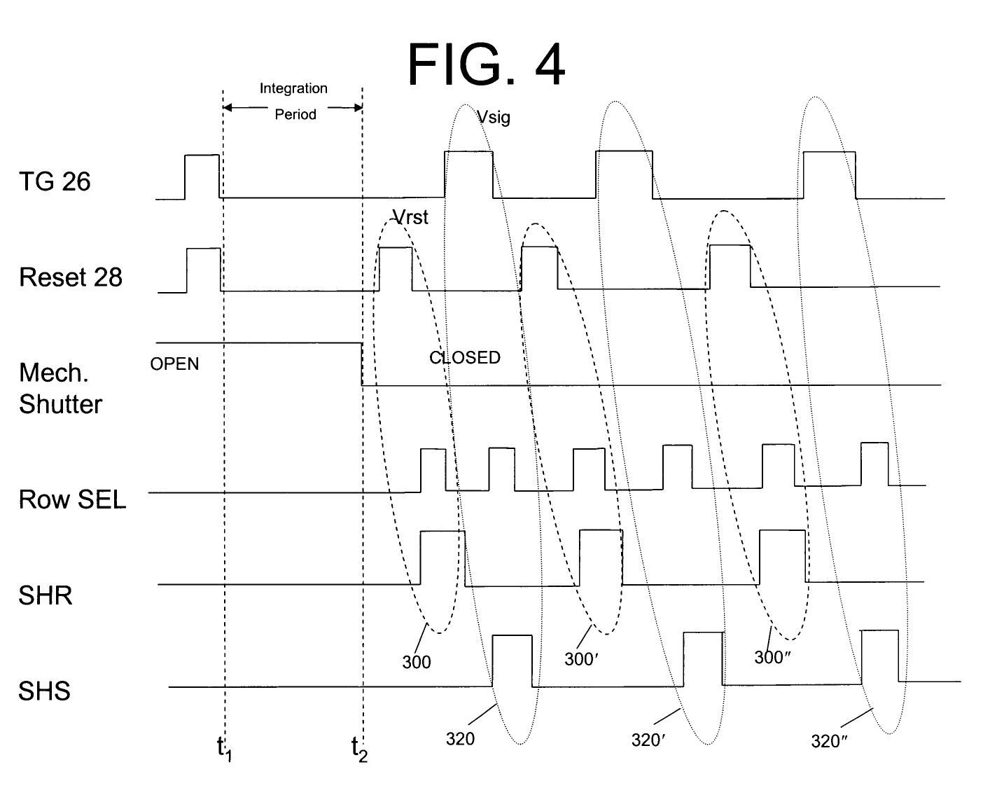

An exemplary output timing for the method of controlling integration time is depicted in FIG. 4. The method of FIG. 4 is discussed with reference to the exemplary 4T pixel sensor cell, as shown in FIG. 3, however the method may be used with any applicable imager pixel sensor cell. At the beginning of the operation, mechanical shutter 11 is opened. After the mechanical shutter 11 is opened, the pixel array 200, formed of a plurality of FIG. 4 pixel circuits, is globally reset by the timing and control circuit 250 (FIG. 2), which issues respective control signals to turn on the reset transistor 28 (reset) and transfer transistor 26 (TG). Reset transistor 28 and transfer transistor 26 are turned on simultaneously in this embodiment. Photodiode 50 is accordingly coupled to a voltage source through reset transistor 28. The timing and control circuit 250 also controls the row and column driver circuitry such that they apply driving voltages to the drive transistors of the selected row and column lines.

At this point indicated as t, in FIG. 4, the floating diffusion region 16 of each pixel is reset to a predetermined voltage and the pixel array 200 is reset due to the simultaneous activation of the transfer transistor 26 and the reset transistor 28. A first integration period now begins at t, after the transfer transistor 26 and reset transistor 28 are turned off. During the integration period, the photodiodes 50 accumulate photogenerated charges. The integration period ends when the mechanical shutter 11 is closed, which occurs at time t₂.

After the end of the integration period, the reset transistor 28 is turned on a second time and a reset voltage (Vᵣₛₜ) is readout. The Vᵣₛₜ is read out by operating a gate of row select transistor 42 and is sampled by an associated sample and hold circuit 261 in response to reset sample signal SHR. The signals for the readout and sampling operation for the reset signal Vᵣₛₜ for a first row readout are shown by the left-most dotted circle 300 in FIG. 4. Each subsequent row has floating diffusion region 16 reset and readout in a similar fashion as indicated by the signals in dotted circles 300′ and 300″.

Accumulated charge from the photodiode 50 for a given row is transferred to floating diffusion region 16, after floating diffusion region 16 is reset and sampled, by turning transfer gate transistor 26 (TG) on a second time. The charge received at the floating diffusion region 16 from photodiode 50 is applied to the gate of source follower transistor 40, which is translated to a voltage (V_{sig}) and subsequently sampled by sample and hold circuitry 261 in response to a signal sample signal SHS and then readout. The signals for readout of V_{sig} for a first row are shown by the dotted circle 320 in FIG. 4. The signals for reading out successive rows, depicted by dotted circles 320′ and 320″, are also shown. Although only two successive rows are shown for readout of the reset Vᵣₛₜ and signal V_{sig} voltages, it must be understood that in operation, any suitable number of a plurality of rows could be readout.

Thus, each successive row is readout as shown in FIG. 4 where the pixels of each row have floating diffusion region 16 read, Vᵣₛₜ sampled, charges transferred to it from photodiode 50 and V_{sig} sampled on a row-by-row fashion, as a rolling readout. The differential signal (Vᵣₛₜ-V_{sig}) for each pixel is digitized by ADC 275, which supplies the digitized pixel signals to an image processor 280 that forms and outputs a digital image (FIG. 2).

FIG. 4 shows a timing diagram for a plurality of pixels, which in this embodiment is readout by a rolling readout technique, where each row is read row by row for one frame. Each subsequent row undergoes a Vᵣₛₜ and V_{sig} readout for each pixel. The readout technique is repeated for subsequent frames. Since the mechanical shutter is closed during readout, blurring effects are reduced and/or eliminated. The use of a mechanical shutter to end the integration period permits a correlated double sampling (CDS) operation that results in reduced kTC noise and a more accurate image.

In another exemplary embodiment, the invention employs a five-transistor (5T) pixel sensor cell such as the one illustrated in FIG. 5. The pixel sensor cell depicted in FIG. 5 is similar to the pixel sensor cell shown in FIG. 3 above, with the addition of a second reset transistor 25 having a reset gate RG2 that is used to reset the photodiode 50 in preparation for an integration period. Photodiode 50 is coupled to a voltage source through the reset transistor 25.

The operation of the pixel sensor cell of FIG. 5 is shown by the timing diagram depicted in FIG. 6. Initially, the mechanical shutter 11 is placed in an open position. The timing and control circuit 250 (FIG. 2) pulses reset transistor 25 (gate RG2) to globally reset all photodiodes 50 of the pixel array. The act of resetting photodiode 50 comprises coupling the photodiode 50 to a voltage source through reset transistor 25. The global reset begins the integration period and the closing of the mechanical shutter 11 ends the integration period (as illustrated by the vertical dotted lines for time points t₁ and t₂).

When the mechanical shutter is closed and the integration period ends, reset transistor 28 is turned on and a reset voltage (Vᵣₛₜ) is readout. The Vᵣₛₜ is readout by operating a gate of row select transistor 42 and then sampling by an associated sample and hold circuit 261 in response to the reset sample signal SHR. The signals for reading out Vᵣₛₜ for a first row are denoted by the dotted circle 340. Each successive row is readout in a similar fashion as indicated by the signals in dotted circles 340′ and 340″.

After a pixel is reset by reset signal 28 and the reset voltage Vᵣₛₜ sampled, charge accumulated in the photodiode 50 is transferred to floating diffusion region 16 by turning transfer gate transistor 26 (TG) on. The charge on the floating diffusion region 16 is applied to the gate of source follower transistor 40, which is translated to a voltage (V_{sig}) and sampled. The signals for reading out V_{sig} for a first row are depicted by dotted circle 350. The differential signal (Vᵣₛₜ-V_{sig}) developed by differential amplifier 262 (FIG. 2) for each pixel is digitized by ADC 275, which supplies the digitized pixel signals to the image processor 280 that forms and outputs a digital image (FIG. 2). FIG. 6 shows a timing diagram for a plurality of pixels and for conducting a rolling readout where rows are read row by row after the integration period ends for one frame. Signals for reading out successive rows, are depicted by dotted circles 350′ and 350″. Although only two successive rows are shown for readout of the reset and signal voltages, it must be understood that in operation, any suitable number of a plurality of rows could be readout.

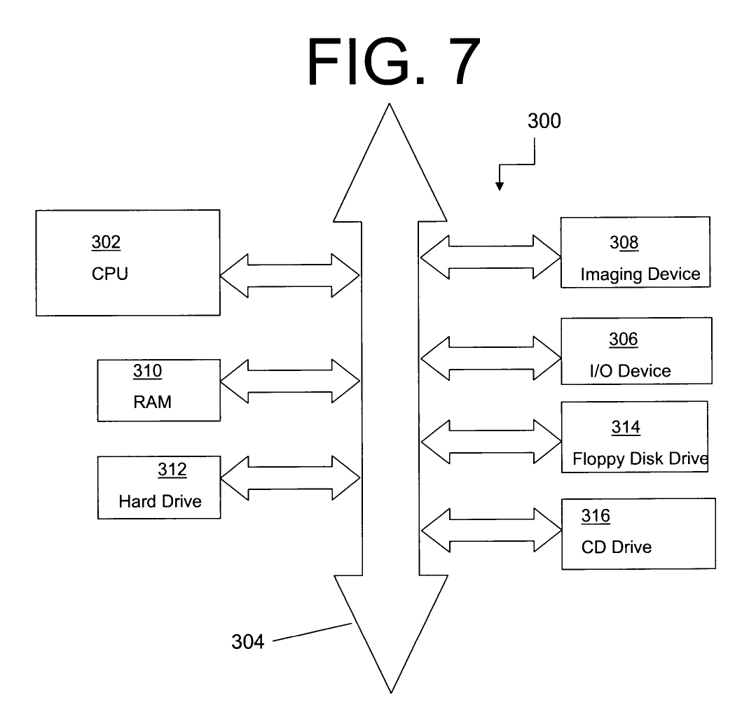

FIG. 7 shows a processor system 300, which includes an imager device 308 (FIG. 2) operated in accordance with the invention. The imager device 308 may receive control or other data from system 300. System 300 includes a processor 302 having a central processing unit (CPU) that communicates with various devices over a bus 304. Some of the devices connected to the bus 304 provide communication into and out of the system 300; an input/output (I/O) device 306 and imager device 308 are such communication devices. Other devices which may be connected to the bus 304, depending on the processor system implementation, provide memory, illustratively including a random access memory (RAM) 310, hard drive 312, and one or more peripheral memory devices such as a floppy disk drive 314 and compact disk (CD) ROM drive 316. The imager device 308 may be constructed with the pixel array 200 having the characteristics of the invention as described above in connection with FIGS. 2-6. The imager device 308 may, in turn, be coupled to processor 302 for image processing, or other image handling operations. The device may be controlled in accordance with the timing diagrams illustrated in FIGS. 4 and 6.

The image sensor having a timing control unit that operates a global reset function, a mechanical shutter operation to mechanically end integration time and a rolling readout function allows a rolling readout to be conducted without blurring the image.

The processes and devices described above illustrate preferred methods and typical devices of many that could be used and produced. The above description and drawings illustrate embodiments which achieve the objects, features, and advantages of the present invention. However, it is not intended that the present invention be strictly limited to the above-described and illustrated embodiments. Any modifications, though presently unforeseeable, of the present invention that come within the spirit and scope of the following claims should be considered part of the present invention.

1. A method of operating a pixel sensor cell of an image sensor comprising:
opening a mechanical shutter;
resetting a photoconversion device to begin an integration period after said shutter is opened;
accumulating photogenerated charge in said photoconversion device during said integration period;
closing said shutter to end said first integration period.

2. A method as in claim 1 wherein said act of resetting said photosensor comprises coupling said photoconversion device to a voltage source.

3. A method as in claim 2 wherein said photoconversion device is coupled to a voltage source through a reset transistor.

4. A method as in claim 3 wherein said photoconversion device is coupled to said voltage source directly by said reset transistor.

5. A method as in claim 3 wherein said photoconversion device is coupled to said voltage source through said reset transistor and a transfer transistor which transfers accumulated charge from said photoconversion device.

6. A method of operating a pixel sensor cell of an image sensor comprising:
opening a mechanical shutter;
resetting a photoconversion device after said mechanical shutter is opened to begin a first integration period;
accumulating charge in said photoconversion device during said first integration period;
resetting a charge collection region and obtaining a reset voltage;
transferring said charge from said photoconversion device to said charge collection region; and
reading out the charge residing in said charge collection region to obtain a pixel signal voltage.

7. The method of claim 6, wherein said pixel sensor cell comprises a reset transistor for resetting said charge collection region and a transfer transistor for transferring charge to said charge collection region and wherein said photoconversion device resetting comprises turning on said reset transistor and said transfer transistor.

8. The method of claim 7, wherein said reset transistor and said transfer transistor are turned on simultaneously.

9. The method of claim 7, wherein said pixel sensor cell further comprises reading out said charge through an output transistor and a row selection transistor.

10. The method of claim 9, wherein said charge is sampled by a sample/hold circuit after said readout.

11. The method of claim 6, wherein said photoconversion resetting comprises coupling said photoconversion device to a voltage source.

12. A method as in claim 11, wherein said photoconversion device is coupled to a voltage source through a reset transistor.

13. A method as in claim 12, wherein said photoconversion device is coupled to said voltage source directly by said reset transistor.

14. A method as in claim 12, wherein said photoconversion device is coupled to said voltage source through said reset transistor and a transfer transistor which transfers accumulated charge from said photoconversion device.

15. The method of claim 6, wherein said image sensor is a CMOS image sensor.

16. The method of claim 6, wherein said charge collection region is a floating diffusion region.

17. A method of operating a pixel of an image sensor comprising:
opening a mechanical shutter;
resetting a photoconversion device after said mechanical shutter is opened to begin a first integration period;
accumulating charge in said photoconversion device during said first integration period;
resetting a charge collection region by operating a gate of a reset transistor to obtain a reset voltage;
reading out said reset voltage at said charge collection region by operating a gate of a row select transistor;
sampling said readout reset voltage;
transferring said charge from said photoconversion device to said charge collection region by operating a gate of a transfer transistor; and
reading out the charge residing in said charge collection region to obtain a pixel signal voltage; and
sampling said pixel signal voltage.

18. The method of claim 17, further comprising producing a differential signal for each pixel which comprises the difference between the sampled reset voltage and the sampled pixel signal voltage.

19. The method of claim 17, wherein said act of reading out the reset voltage comprises reading out the reset voltage from the charge collection region.

20. The method of claim 17, wherein said photoconversion device resetting comprises turning on said reset transistor and said transfer transistor before said integration period.

21. The method of claim 20, wherein said reset transistor and said transfer transistor are turned on simultaneously.

22. The method of claim 17, wherein said photoconversion resetting comprises coupling said photoconversion device to a voltage source.

23. The method of claim 22, wherein said photoconversion device is coupled to a voltage source through a reset transistor.

24. The method of claim 23, wherein said reset transistor is part of a five transistor circuit.

25. The method of claim 24, wherein said five transistor circuit comprises at least two reset transistors, one for resetting said photoconversion device and one for resetting said charge collection region, at least one transfer transistor, at least one row select transistor and at least one source follower transistor.

26. The method of claim 25 wherein said photoconversion device is coupled to said voltage source directly by one of said at least two reset transistors.

27. The method of claim 22 wherein said photoconversion device is coupled to said voltage source through said reset transistor and a transfer transistor which transfers accumulated charge from said photoconversion device.

28. The method of claim 17, wherein said image sensor is a CMOS image sensor.

29. The method of claim 17, wherein said charge collection region is a floating diffusion region.

30. The method of claim 17, wherein said act of reading out charge further comprises reading out said charge through an output transistor and a row selection transistor.

31. A method of operating a plurality of pixels in an array of an image sensor comprising:
opening a mechanical shutter;
globally resetting the pixels to begin a first integration period;
accumulating charge in at least one photoconversion device of each pixel;
closing said shutter to end said first integration period;
resetting the pixels to obtain a respective reset voltage for each pixel and reading out said reset voltage;
transferring accumulated charge from each photoconversion device to an associated charge collection region of each pixel; and
reading out the charge residing in each charge collection region to obtain a respective signal voltage for each pixel.

32. The method of claim 31, wherein the reset and signal voltages of said pixels are readout on a row by row basis after the mechanical shutter is closed and the first integration period ends.

33. The method of claim 31, wherein said global reset is conducted by turning on a reset transistor and a transfer transistor within each pixel to couple the photoconversion device of each pixel to a voltage source.

34. The method of claim 33, wherein said reset transistor and said transfer transistor are turned on simultaneously to begin said integration period.

35. The method of claim 31, wherein said global reset is conducted by turning on a reset transistor in each pixel for resetting a photoconversion device.

36. The method of claim 31, wherein said image sensor is a CMOS image sensor.

37. The method of claim 31, wherein said charge collection region is a floating diffusion region.

38. The method of claim 37, wherein said act of reading out the reset voltage comprises reading out the reset voltage from said floating diffusion region.

39. The method of claim 31, wherein said pixel comprises four transistors.

40. The method of claim 31, wherein said pixel comprises five transistors.

41. A pixel sensor cell comprising:
a photoconversion device for accumulating charge;
a reset transistor and a transfer transistor for resetting said photoconversion device to begin an integration period;
a mechanical shutter, wherein said mechanical shutter is open during the resetting of said photoconversion device and closed to end said integration period;
a charge collection region for receiving said charge from said photoconversion device; and
a readout circuit for reading out said charge from said charge collection region.

42. The pixel sensor cell of claim 41, wherein said photoconversion device is coupled to a voltage source.

43. The pixel sensor cell of claim 42, wherein said photoconversion device is coupled to a voltage source through a reset transistor.

44. The pixel sensor cell of claim 43, wherein said photoconversion device is coupled to said voltage source through said reset transistor and a transfer transistor which transfers accumulated charge from said photoconversion device.

45. The pixel sensor cell of claim 41, wherein said pixel sensor cell is part of a CMOS imager.

46. The pixel sensor cell of claim 41, wherein a reset voltage is readout after said shutter is closed.

47. The pixel sensor cell of claim 46, wherein a signal voltage is readout after said reset voltage is readout.

48. The pixel sensor cell of claim 41, wherein said pixel sensor cell comprises four transistors.

49. The pixel sensor cell of claim 41, wherein said readout circuitry reads out said charge through an output transistor and a row selection transistor.

50. The pixel sensor cell of claim 49, wherein said charge is sampled by a sample/hold circuit after said readout.

51. A pixel sensor cell comprising:
a photoconversion device for accumulating charge, said photoconversion device being coupled to and reset by a reset transistor to begin an integration period;
a mechanical shutter, wherein said mechanical shutter is open during the resetting of said photoconversion device and closed to end said integration period;
a charge collection region for receiving said charge from said photoconversion device; and
a readout circuit for reading out said charge from said charge collection region.

52. The pixel sensor cell of claim 51, wherein said photoconversion device is coupled to a voltage source.

53. The pixel sensor cell of claim 52, wherein said photoconversion device is coupled to a voltage source through a reset transistor.

54. The pixel sensor cell of claim 53, wherein said reset transistor is part of a five transistor circuit.

55. The pixel sensor cell of claim 54, wherein said five transistor circuit comprises at least two reset transistors, one for resetting said photoconversion device and one for resetting said charge collection region, at least one transfer transistor, at least one row select transistor and at least one source follower transistor.

56. The pixel sensor cell of claim 55, wherein said photoconversion device is coupled to said voltage source directly by one of said at least two reset transistors.

57. The pixel sensor cell of claim 51, wherein said readout circuitry reads out said charge through an output transistor and a row selection transistor.

58. The pixel sensor cell of claim 57, wherein said charge is sampled by a sample/hold circuit after said readout.

59. The pixel sensor cell of claim 51, wherein said pixel sensor cell is part of a CMOS imager.

60. A timing control circuit for an imager array comprising:
circuitry for applying driving voltage to at least one transistor of a pixel sensor cell of the array, wherein said transistor resets at least one photoconversion device to begin an integration period;
a mechanical shutter for ending said integration period; and
a readout circuit, wherein said readout circuit uses a rolling readout technique after said integration period ends.

61. The circuit of claim 60, wherein said pixel sensor cell further comprises a reset transistor for resetting a charge collection region and a transfer transistor for transferring charge to said charge collection region after said integration period.

62. The circuit of claim 61, wherein said reset transistor and said transfer transistor are turned on simultaneously before said integration period to reset said photoconversion device.

63. The circuit of claim 60, wherein said photoconversion device is coupled to a voltage source.

64. The circuit of claim 63, wherein said photoconversion device is coupled to a voltage source through a reset transistor.

65. The circuit of claim 64, wherein said photoconversion device is coupled to said voltage source directly by said reset transistor.

66. The circuit of claim 64, wherein said photoconversion device is coupled to said voltage source through said reset transistor and a transfer transistor which transfers accumulated charge from said photoconversion device.

67. The circuit of claim 64, wherein said reset transistor is part of a five transistor circuit.

68. The circuit of claim 67, wherein said five transistor circuit comprises at least two reset transistors, one for resetting said photoconversion device and one for resetting said charge collection region, at least one transfer transistor, at least one row select transistor and at least one source follower transistor.

69. The circuit of claim 64, wherein said photoconversion device is coupled to said voltage source directly by one of said at least two reset transistors.

70. The circuit of claim 60, wherein said rolling readout is conducted by reading out successive rows of said imager array.

71. The circuit of claim 60, wherein said imager array is part of a CMOS imager.

72. A processor system comprising:
a processor; and
an imager coupled to said processor, said imager comprising:
a timing control circuit for globally resetting pixel sensor cells of said imager before an integration period,
a mechanical shutter for ending said integration period, and
a readout circuit, wherein said readout circuit uses a rolling readout technique after said integration period ends.

73. The system of claim 72, wherein said pixel sensor cell comprises a reset transistor for resetting said charge collection region and a transfer transistor for transferring charge to said charge collection region after said integration period.

74. The system of claim 73, wherein said reset transistor and said transfer transistor are turned on simultaneously before said integration period to reset said photoconversion device.

75. The system of claim 72, wherein said photoconversion device is coupled to a voltage source.

76. The system of claim 75, wherein said photoconversion device is coupled to a voltage source through a reset transistor.

77. The system of claim 76, wherein said photoconversion device is coupled to said voltage source directly by said reset transistor.

78. The system of claim 76, wherein said photoconversion device is coupled to said voltage source through said reset transistor and a transfer transistor which transfers accumulated charge from said photoconversion device.

79. The system of claim 76, wherein said reset transistor is part of a five transistor circuit.

80. The system of claim 79, wherein said five transistor circuit comprises at least two reset transistors, one for resetting said photoconversion device and one for resetting said charge collection region, at least one transfer transistor, at least one row select transistor and at least one source follower transistor.

81. The system of claim 80, wherein said photoconversion device is coupled to said voltage source directly by one of said at least two reset transistors.

82. The system of claim 72, wherein said rolling readout is conducted by reading out successive rows of said imager array.

83. The system of claim 72, wherein said imager array is part of a CMOS imager.

84. An imager device comprising:
a pixel array comprising:
a plurality of pixels;
readout circuitry for said array;
global circuitry for resetting photoconversion devices of said array to begin an integration period; and
a mechanical shutter for ending said integration period.

85. The device of claim 84, wherein said pixels are readout on a row by row basis after the mechanical shutter is closed and the first integration period ends.

86. The device of claim 84, wherein said global reset is conducted by turning on a reset transistor and a transfer transistor within each pixel to couple the photoconversion device of each pixel to a voltage source.

87. The device of claim 86, wherein said reset transistor and said transfer transistor are turned on simultaneously to begin said integration period.

88. The device of claim 84, wherein said readout circuitry comprises circuitry for reading out reset voltages and output voltages for said plurality of pixels.

89. The device of claim 84, wherein said global circuitry for resetting said photoconversion devices comprises circuitry for coupling said photoconversion device to a voltage source.

90. The device of claim 89, wherein said photoconversion device is coupled to a voltage source through a reset transistor.

91. The device of claim 90, wherein said photoconversion device is coupled to said voltage source directly by said reset transistor.

92. The device of claim 90, wherein said photoconversion device is coupled to said voltage source through said reset transistor and a transfer transistor which transfers accumulated charge from said photoconversion device.

93. An imager integrated circuit comprising:
a doped layer formed in a substrate;
an array of pixel sensor cells formed in said doped layer, wherein said pixel sensor cells are globally reset before an integration period; and
signal processing circuitry formed in said substrate and electrically connected to the array for receiving and processing pixel signals representing an image acquired by the array and for providing output data representing said image.

94. The imager integrated circuit of claim 93, wherein said pixel sensor cell further comprises a reset transistor for resetting a charge collection region and a transfer transistor for transferring charge to said charge collection region after said integration period.

95. The imager integrated circuit of claim 94, wherein said reset transistor and said transfer transistor are turned on simultaneously before said integration period to reset said photoconversion device.

96. The imager integrated circuit of claim 94, wherein said photoconversion device is coupled to a voltage source.

97. The imager integrated circuit of claim 96, wherein said photoconversion device is coupled to a voltage source through a reset transistor.

98. The imager integrated circuit of claim 97, wherein said photoconversion device is coupled to said voltage source directly by said reset transistor.

99. The imager integrated circuit of claim 97, wherein said photoconversion device is coupled to said voltage source through said reset transistor and a transfer transistor which transfers accumulated charge from said photoconversion device.

100. The imager integrated circuit of claim 97, wherein said reset transistor is part of a five transistor circuit.

101. The imager integrated circuit of claim 100, wherein said five transistor circuit comprises at least two reset transistors, one for resetting said photoconversion device and one for resetting said charge collection region, at least one transfer transistor, at least one row select transistor and at least one source follower transistor.

102. The imager integrated circuit of claim 101, wherein said photoconversion device is coupled to said voltage source directly by one of said at least two reset transistors.

103. The imager integrated circuit of claim 93, wherein said signal circuitry further comprises readout circuitry for reading out said signals.

104. The imager integrated circuit of claim 103, wherein said readout circuitry reads out said signals using a rolling readout.

105. The imager integrated circuit of claim 93, wherein said rolling readout is conducted by reading out successive rows of said imager array.

106. The imager integrated circuit of claim 93, wherein said imager is a CMOS imager.
